(19) United States
(12) Patent Application Publication
(10) Pub. No.: US 2019/0384436 A1
(43) Pub. Date: Dec. 19, 2019

(54) INPUT DEVICE AND ELECTRONIC DEVICE APPLICABLE TO INTERACTION CONTROL

(71) Applicant: ACER INCORPORATED, New Taipei City (TW)

(72) Inventor: Chueh-Pin Ko, New Taipei City (TW)

(21) Appl. No.: 16/159,700

(22) Filed: Oct. 14, 2018

(30) Foreign Application Priority Data
Jun. 13, 2018 (TW) 107120345

(51) Int. Cl. G06F 3/041; G06F 3/044; G06F 3/0354; G06F 3/038

(52) U.S. Cl. CPC G06F 3/0412; G06F 3/0416; G06F 3/0383; G06F 3/03545; G06F 3/044

(57) ABSTRACT

An input device and electronic device applicable to interaction control are provided. The input device includes a first terminal and a second terminal, and the electronic device includes a touch-sensitive panel and a processing circuit. The touch-sensitive panel performs sensing on the first and the second terminals, to detect first and second detection points respectively corresponding to the first and the second terminals. When the input device is put on the touch-sensitive panel, the first detection point corresponds to a location of the first terminal on the touch-sensitive panel, and the second detection point corresponds to a location of the second terminal on the touch-sensitive panel. When it is detected that a distance between the first detection point and the second detection point is equal to a predetermined distance, the touch-sensitive panel generates a detection result to indicate that the input device is put on the touch-sensitive panel.

### BACKGROUND OF THE INVENTION

### 1. Field of the Invention

The present invention relates to controlling of a user interface, and more particularly, to an input device and an electronic device applicable to interaction control.

### 2. Description of the Prior Art

Interaction mechanisms can be seen in various electronic devices, such as multi-functional mobile phones. This type of interaction mechanism typically provides interactions between humans and machines, rather than machine-machine interactions. Some related arts attempt to provide interactions between machines, but as a result, the overall cost is raised and the volume of the entire architecture becomes too large. Therefore, there is a need for a novel method and associated architecture to achieve interaction mechanisms between devices.

### SUMMARY OF THE INVENTION

An objective of the present invention is therefore to provide an input device and electronic device applicable to interaction control, in order to solve the problems mentioned above.

Another objective of the present invention is to provide an input device and electronic device applicable to interaction control, in order to achieve an interaction mechanism between devices.

At least one embodiment of the present invention provides an input device applicable to interact with an electronic device. The input device comprises a first terminal and a second terminal. The first terminal is arranged to trigger a touch-sensitive panel of the electronic device to detect a first detection point corresponding to the first terminal, wherein when the input device is placed on the touch-sensitive panel, the first detection point corresponds to a location of the first terminal on the touch-sensitive panel. The second terminal is arranged to trigger the touch-sensitive panel to detect a second detection point corresponding to the second terminal, wherein when the input device is placed on the touch-sensitive panel, the second detection point corresponds to a location of the second terminal on the touch-sensitive panel. When a distance between the first detection point and the second detection point is equal to a predetermined distance, the touch-sensitive panel generates a detection result to indicate that the input device is placed on the touch-sensitive panel; and at least according to the detection result, the electronic device controls a display content outputted by a display module of the electronic device to correspond to the input device.

At least one embodiment of the present invention provides an electronic device applicable to interact with an input device. The electronic device comprises a touch panel and a processing circuit. The touch-sensitive panel is arranged to perform sensing on a first terminal and a second terminal of the input device, in order to detect a first detection point corresponding to the first terminal and a second detection point corresponding to the second terminal, wherein when the input device is placed on the touch-sensitive panel, the first detection point corresponds to a location of the first terminal on the touch-sensitive panel, and the second detection point corresponds to a location of the second terminal on the touch-sensitive panel, and when a distance between the first detection point and the second detection point is equal to a predetermined distance, the touch-sensitive panel generates a detection result to indicate that the input device is placed on the touch-sensitive panel. The processing circuit is coupled to the touch-sensitive panel, and arranged to control operations of the electronic device. At least according to the detection result, the processing circuit controls a display content outputted by a display module of the electronic device to correspond to the input device.

An advantage provided by the present invention is that proper controls maybe provided towards operations of the electronic device, and more particularly, an interaction mechanism may be achieved between devices in a limited space, thus avoiding various problems encountered in related art techniques. In addition, implementing embodiments of the present invention will not significantly raise the overall cost.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an interaction system according to an embodiment of the present invention, wherein the interaction system comprises an input device and an electronic device.

FIG. 2 is a diagram illustrating a working flow of a method for performing interaction control according to an embodiment of the present invention.

FIG. 3 is a diagram illustrating implementation details of the input device according to an embodiment of the present invention.

FIG. 4 is a diagram illustrating implementation details of the input device according to another embodiment of the present invention.

FIG. 5 is a diagram illustrating implementation details of the input device according to another embodiment of the present invention.

FIG. 6 is a diagram illustrating implementation details of the input device according to another embodiment of the present invention.

FIG. 7 is a diagram illustrating implementation details of the electronic device according to an embodiment of the present invention.

FIG. 8 is a diagram illustrating implementation details of the interaction system according to an embodiment of the present invention.

FIG. 9 is a diagram illustrating a working flow of the method according to an embodiment of the present invention.

### DETAILED DESCRIPTION

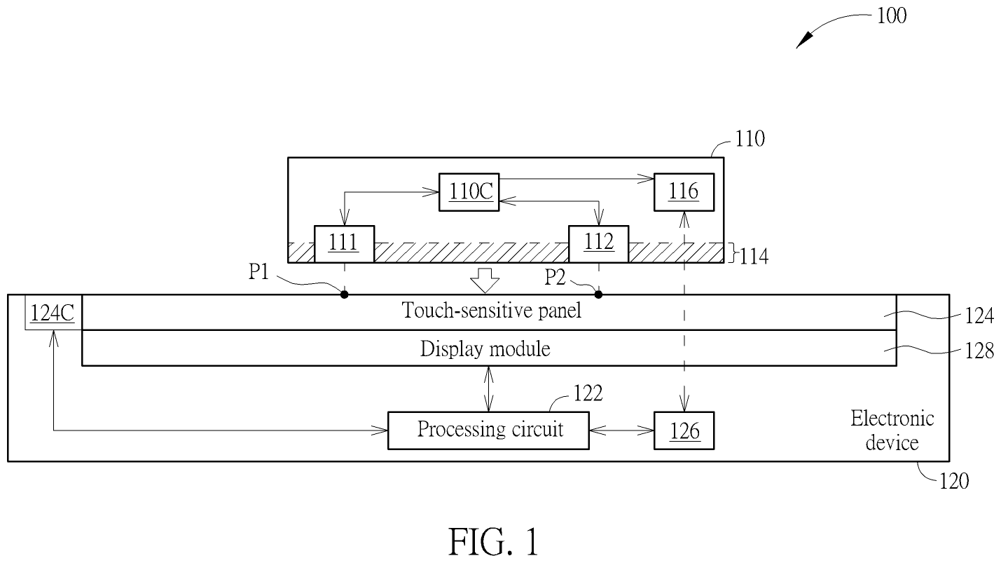

FIG. 1 is a diagram illustrating an interaction system 100 according to an embodiment of the present invention, wherein the interaction system 100 may comprise an input device 110 and an electronic device 120. Examples of the input device 110 may include, but are not limited to: an active stylus, digital ruler, digital protractor, etc. Examples of the electronic device 120 may include, but are not limited to: an all-in-one personal computer (PC), tablet, multi-functional mobile phone, etc., wherein the size of the electronic device 120 is larger than the size of the input device 110 in general, but the present invention is not limited thereto.

As shown in FIG. 1, the input device 110 may comprise a control circuit 110C (e.g. a microprocessor, memory and associated circuits), terminals 111 and 112, a coplanar structure 114 and a communications module 116 (e.g. wireless communications module conforming to Bluetooth, Wi-Fi, etc.), and the electronic device 120 may comprise a processing circuit 122 (e.g. a processor, memory, bus and associated circuits), a touch-sensitive panel 124 as well as its control circuit 124C, a communications module 126 (e.g. wireless communications module conforming to Bluetooth, Wi-Fi, etc.), and a display module 128. As long as the implementation of the present invention is not hindered, the architecture of the interaction system 100 can be modified. For example, the quantity, type, arrangement, etc. of elements of the interaction system 100 can be changed. In another example, some elements of any of the input device 110 and the electronic device 120 may be integrated into the same module, e.g. the touch-sensitive panel 124 and display module 128 of the electronic device 120 can be integrated as a touch screen.

According to this embodiment, the control circuit 110C and the processing circuit 122 may be arranged to control operations of the input device 110 and the electronic device 120, respectively, and the terminals 111 and 112 and the touch-sensitive panel 124 may be arranged to perform touch control, and more particularly, may perform interaction control related to the input device 110 and the electronic device 120 via the dual detection point configuration. The terminal 111 may trigger the touch-sensitive panel 124 to detect a detection point P1 corresponding to the terminal 111, and the terminal 112 may trigger the touch-sensitive panel 124 to detect a detection point P2 corresponding to the terminal 112, wherein when the input device 110 is placed on the touch-sensitive panel 124, the detection point P1 corresponds to the location of the terminal 111 on the touch-sensitive panel 124, and the detection point P2 corresponds to the location of the terminal 112 on the touch-sensitive panel 124. In addition, the coplanar structure 114 may be arranged to install the terminals 111 and 112, and may make the terminals 111 and 112 be located at the same plane, wherein when the input device 110 is placed on the touch-sensitive panel 124, the coplanar structure 114 may be arranged towards the touch-sensitive panel 124 to allow the touch-sensitive panel 124 to detect and locate the detection points P1 and P2. For example, when the user moves the input device 110 to another location on the touch-sensitive panel 124, the touch-sensitive panel 124 may detect that the distance D between the detection points P1 and P2 remains unchanged. Further, when there is a need, the communications modules 116 and 126 may be arranged to perform wireless communications for the input device 110 and the electronic device 120 respectively, in order to allow the input device 110 and the electronic device 120 to exchange information.

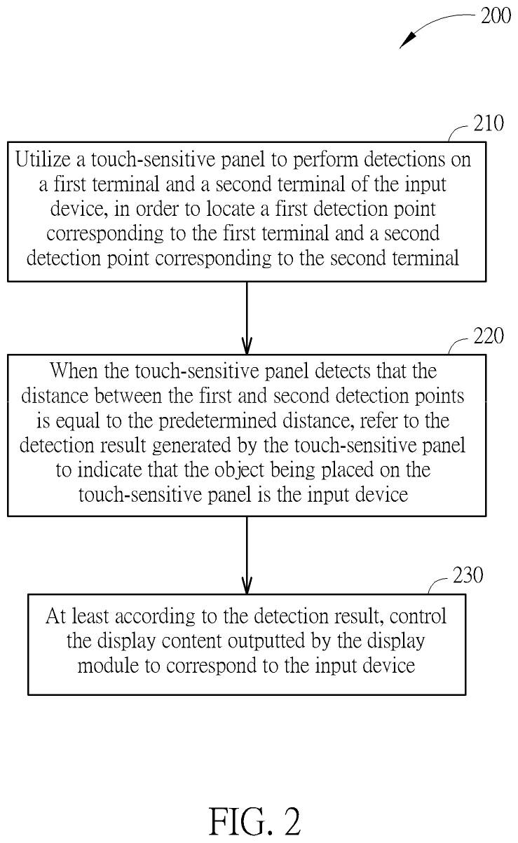

FIG. 2 is a diagram illustrating a working flow 200 of a method for performing interaction control according to an embodiment of the present invention, wherein the method is applicable to the interaction system 100, the input device 110, the electronic device 120, the control circuit 110C and the processing circuit 122, as well as other elements shown in FIG. 1. The control circuit 110C and the processing circuit 122 may control operations of the input device 110 and the electronic device 120, respectively, according to the method. For better understanding, the first terminal and the second terminal in the working flow 200 may be described with the terminals 111 and 112, respectively, and the first detection point corresponding to the first terminal and the second detection point corresponding to the second terminal may be described with the detection points P1 and P2, respectively.

In Step 210, the electronic device 120 (especially the processing circuit 122 thereof) may utilize the touch-sensitive panel 124 to perform sensing on the terminals 111 and 112 of the input device 110, in order to detect (more particularly, locate) the detection point P1 corresponding to the terminal 111 and the detection point P2 corresponding to the terminal 112. When the input device 110 is placed on the touch-sensitive panel 124, the terminals 111 and 112 may touch or approach the touch-sensitive panel 124, to allow the touch-sensitive panel 124 to detect (more particularly, locate) the detection points P1 and P2. Since the terminals 111 and 112 may be fixed by the coplanar structure 114, no matter whether the input device 110 is moved to somewhere else on the touch-sensitive panel 124 or is repositioned on the touch-sensitive panel 124, the distance D (the distance between the detection points P1 and P2) detected by the touch-sensitive panel 124 may remain unchanged and equal to a predetermined distance.

In Step 220, when the touch-sensitive panel 124 detects that the distance D between the detection points P1 and P2 is equal to the predetermined distance, the electronic device 120 (especially the processing circuit 122 thereof) may refer to a detection result generated by the touch-sensitive panel 124 to indicate that the object being placed on the touch-sensitive panel 124 is the input device 110. For example, an input device database may comprise a mapping relationship between the predetermined distance and an identifier (ID) of the input device 110, wherein the control circuit 124C may be built-in to the touch-sensitive panel 124, and the input device database may be positioned in the control circuit 124C (for example, a non-volatile memory therein). Based on the input device database, the touch-sensitive panel 124 may generate the detection result which comprises the ID. More particularly, the input device database may comprise the mapping relationships between a plurality of predetermined distances (e.g. the predetermined distance) and respective IDs of a plurality of input devices (e.g. the input device 110), wherein the plurality of input devices comprise the input device 110, said respective IDs comprise the ID, and the plurality of predetermined distances comprise the predetermined distance, and differ from one another. Hence, through mapping the predetermined distance to the ID, the touch-sensitive panel 124 detects that the object placed on the touch-sensitive panel 124 is the input device 110.

In Step 230, at least according to the detection result, the electronic device 120 (especially the processing circuit 122 thereof) may control the display content outputted by the display module 128 to correspond to the input device 110. For example, the display content outputted by the display module 128 may be the modified images in response to the interaction control. Examples of the display content corresponding to the input device 110 may include, but are not limited to: the function menu of the input device 110, the auxiliary image of the input device 110 (such as a predetermined image that represents the input device 110), associated information (such as icons, symbols, etc.) of the input device 110, and multimedia (such as videos, photos, etc.) related to the input device 110. Under the control of the processing circuit 122, the display module 128 may display images regarding interaction control (such as the images modified in response to the interaction control) for the electronic device 120, in order to improve the user experience.

According to some embodiments, one or more steps may be inserted into the working flow 200, and/or one or more existing steps in the working flow 200 may be modified or removed. According to some embodiments, when the distance D between the detection points P1 and P2 is detected to be equal to the predetermined distance, the touch-sensitive panel 124 may output the detection result and the auxiliary information corresponding to the input device 110, wherein according to the detection result and the auxiliary information, the electronic device 120 (especially the processing circuit 122 thereof) may control the display content outputted by the display module 128 to correspond to the input device 110.

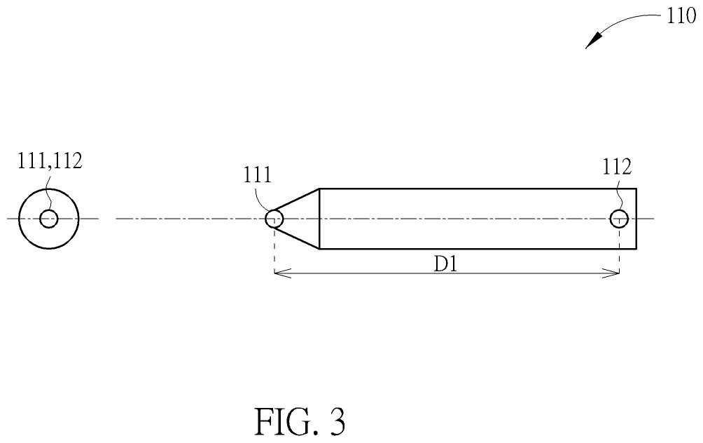

FIG. 3 is a diagram illustrating implementation details of the input device 110 according to an embodiment of the present invention. As shown in the right half of FIG. 3, the input device 110 may be implemented as an active stylus, and the terminals 111 and 112 may be set on a symmetry axis of the input device 110, and may be located at the left side and the right side of the input device 110, respectively. The distance Dl between the respective center points of the terminals 111 and 112 may be taken as an example of the predetermined distance. When viewed from this symmetry axis, the terminals 111 and 112 may overlap each other, as shown in the side-view on the left side of FIG. 3. For better understanding, assume the ID of this active stylus is ID1. In Step 220, when the touch-sensitive panel 124 detects that the distance D between the detection points P1 and P2 is equal to the predetermined distance such as the distance D1, the electronic device 120 (especially the processing circuit 122 thereof) may refer to the detection result (such as the ID ID1) generated by the touch-sensitive panel 124 to indicate that the object being placed on the touch-sensitive panel 124 is this active stylus. In Step 230, at least according to the detection result (such as the ID ID1), the electronic device 120 (especially the processing circuit 122 thereof) may control the display module 128 to display the display content corresponding to this active stylus, such as its function menu and associated information (e.g. name and symbol).

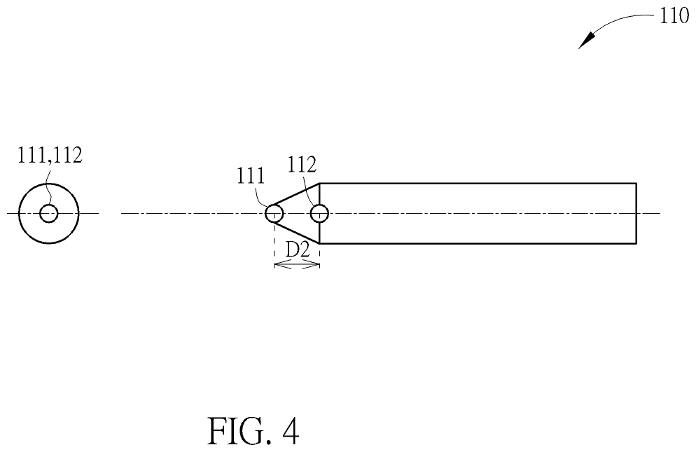

FIG. 4 is a diagram illustrating implementation details of the input device 110 according to another embodiment of the present invention. As shown on the right half of FIG. 4, the input device 110 may be implemented as an active stylus, and the terminals 111 and 112 may be set on the same symmetry axis of the input device 110, and may be respectively located at two adjacent points on the left side of the input device 110. The distance D2 between the respective center points of the terminals 111 and 112 may be taken as an example of the predetermined distance. When viewed from this symmetry axis, the terminals 111 and 112 may overlap each other, as shown in the side-view on the left side of FIG. 4. For better understanding, assume the ID of this active stylus is ID2. In Step 220, when the touch-sensitive panel 124 detects that the distance D between the detection points P1 and P2 is equal to the predetermined distance such as the distance D2, the electronic device 120 (especially the processing circuit 122 thereof) may refer to the detection result (such as the ID ID2) generated by the touch-sensitive panel 124 to indicate that the object being placed on the touch-sensitive panel 124 is this active stylus. In Step 230, at least according to the detection result (such as the ID ID2), the electronic device 120 (especially the processing circuit 122 thereof) may control the display module 128 to display the display content corresponding to this active stylus, such as its function menu and associated information (e.g. name and symbol).

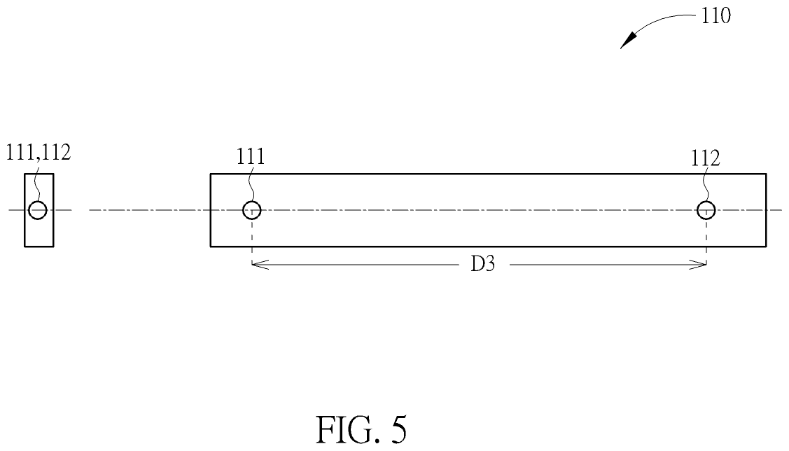

FIG. 5 is a diagram illustrating implementation details of the input device 110 according to another embodiment of the present invention. As shown on the right half of FIG. 5, the input device 110 may be implemented as a digital ruler, and the terminals 111 and 112 may be set on a symmetry axis of the input device 110, and may be respectively positioned at the left side and the right side of the input device 110. The distance D3 between the respective center points of the terminals 111 and 112 may be taken as an example of the predetermined distance. When viewed from this symmetry axis, the terminals 111 and 112 may overlap each other, as shown in the side-view on the left side of FIG. 5. For example, the digital ruler may comprise a physical structure and a virtual structure. More particularly, the physical structure may be a rectangular main structure (the main structure in a rectangular shape) that comprises the terminals 111 and 112, and the virtual structure may be a rectangular secondary structure (the secondary structure in a rectangular shape) displayed by the display module 128, wherein this rectangular secondary structure may be taken as an example of the display content corresponding to the input device 110 as mentioned in Step 230, but the present invention is not limited thereto. For better understanding, assume that the ID of the digital ruler is ID3. In Step 220, when the touch-sensitive panel 124 detects that the distance D between the detection points P1 and P2 is equal to the predetermined distance such as the distance D3, the electronic device 120 (especially the processing circuit 122 thereof) may refer to the detection result (such as the ID ID3) generated by the touch-sensitive panel 124 to indicate that the object placed on the touch-sensitive panel 124 is the digital ruler. In Step 230, at least according to the detection result (such as the ID ID3), the electronic device 120 (especially the processing circuit 122 thereof) may control the display module 128 to display the display content corresponding to the digital ruler, such as the rectangular secondary structure and the scales thereon, etc. According to some embodiments, the type and style of the digital ruler may be modified, and the virtual structure may vary correspondingly.

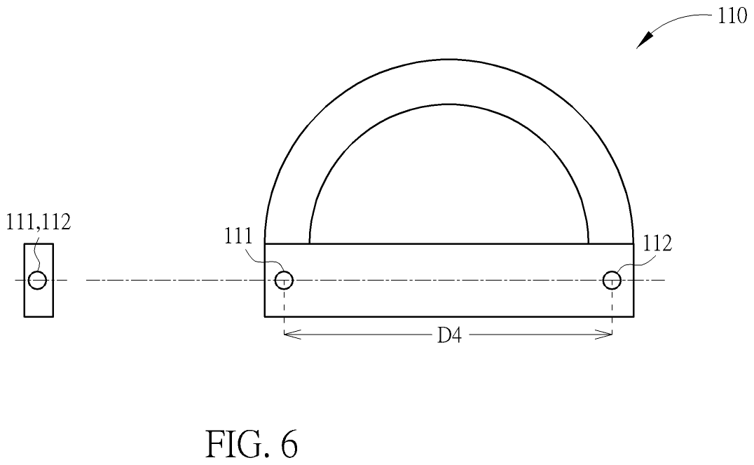

FIG. 6 is a diagram illustrating implementation details of the input device 110 according to another embodiment of the present invention. As shown in the right half of FIG. 6, the input device 110 may be implemented as a digital protractor, and the terminals 111 and 112 may be set on a symmetry axis of the input device 110, and may be respectively positioned at the left side and the right side of the input device 110. The distance D4 between the respective center points of the terminals 111 and 112 may be taken as an example of the predetermined distance. When viewed from this symmetry axis, the terminals 111 and 112 may overlap each other, as shown in the side-view on the left side of FIG. 6. For example, the digital protractor may comprise a physical structure and virtual structure, and more particularly, the physical structure may be a rectangular main structure with the terminals 111 and 112 set therein, and the virtual structure may be a curved/semicircular secondary structure displayed by the display module 128, wherein the curved/semicircular secondary structure maybe taken as an example of the display content corresponding to the input device 110 as mentioned in Step 230, but the present invention is not limited thereto. For better understanding, assume that the ID of the digital protractor is ID4. In Step 220, when the touch-sensitive panel 124 detects that the distance D between the detection points P1 and P2 is equal to the predetermined distance such as the distance D4, the electronic device 120 (especially the processing circuit 122 thereof) may refer to the detection result (such as the ID ID4) generated by the touch-sensitive panel 124 to indicate that the object being placed on the touch-sensitive panel 124 is the digital protractor. In Step 230, at least according to the detection result (such as the ID ID4), the electronic device 120 (especially the processing circuit 122 thereof) may control the display module 128 to display the display content corresponding to the digital protractor, such as the curved/semicircular secondary structure and the scale thereon, etc. According to some embodiments, the type and the style of the digital protractor may be changed, and the virtual structure may change correspondingly.

For better understanding, the plurality of input devices may comprise the examples of the input device 110 as mentioned in the embodiments of FIGS. 3-6, wherein based on the mapping relationships in the input device database, the plurality of predetermined distances (such as the predetermined distances D1, D2, D3, D4 . . . ) may be respectively mapped to the respective IDs (such as the IDs ID1, ID2, ID3, ID4 . . . ) of the plurality of input devices. In addition, any two of the predetermined distances D1, D2, D3, D4 . . . are different from each other, and any two of the IDs ID1, ID2, ID3, ID4 . . . are also different from each other.

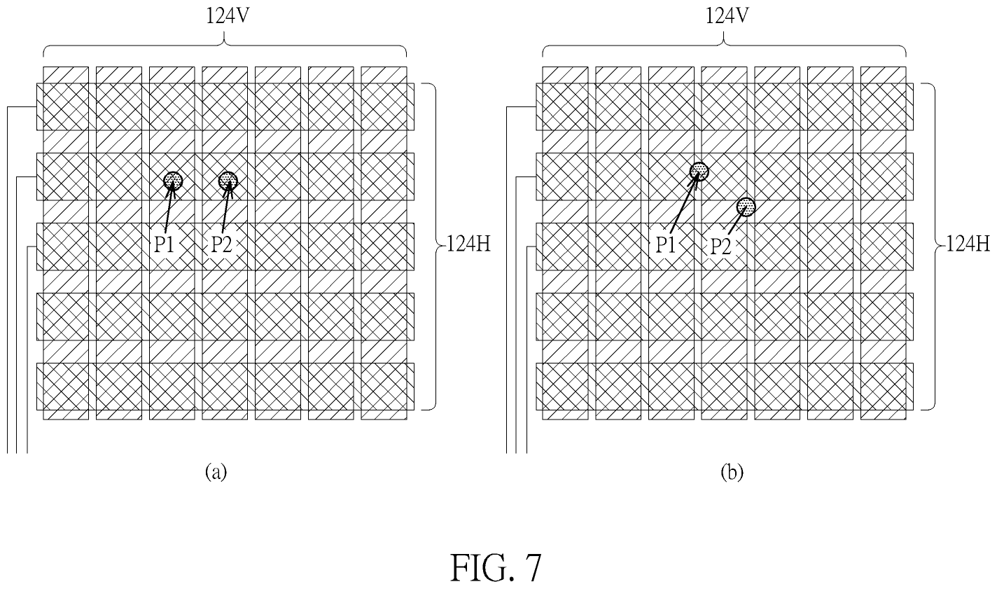

FIG. 7 is a diagram illustrating implementation details of the electronic device according to an embodiment of the present invention. The touch-sensitive panel 124 may comprise multiple sets of detection wire traces, such as the detection wire traces 124H and 124V (depicted by different shaded patterns in FIG. 7) that respectively correspond to horizontal and vertical directions. Within any set of the multiple sets of detection wire traces (such as the detection wire traces 124V or 124H), it is assumed that the distance between the respective center lines of any two adjacent traces is “d”, wherein the distance d may be equal to 4.2 (mm), or 6 (mm), or any of other predetermined values. In Example (a), when the detection points P1 and P2 are positioned on a horizontal line or vertical line, the designated value of the predetermined distance (such as any of the predetermined distances D1, D2, D3, D4 . . . ) is preferably greater than or equal to the distance d, in order to allow the touch-sensitive panel 124 to correctly detect the aforementioned distance D. In Example (b), when the detection points P1 and P2 are positioned on a non-crossing slash, the value of the predetermined distance (such as any of the predetermined distances D1, D2, D3, D4 . . . ) is preferably greater than or equal to the distance (r * d), to allow the touch-sensitive panel 124 to correctly detect the aforementioned distance D, wherein r may be 1.4142 . . . or a simpler value such as that rounded to 1.5.

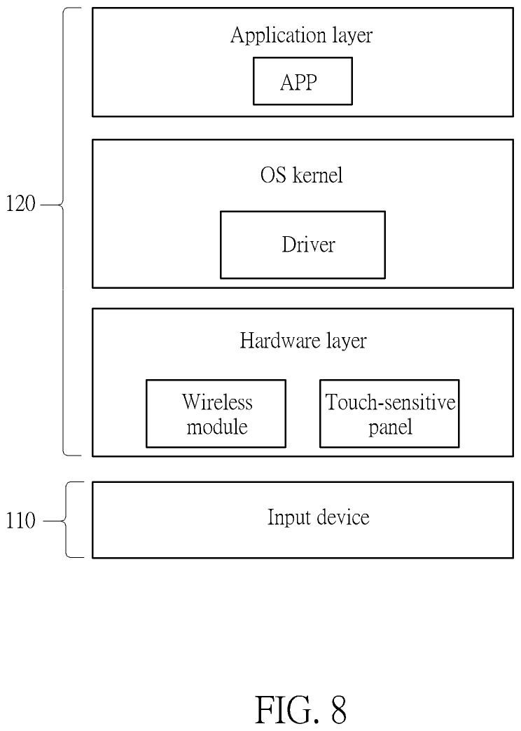

FIG. 8 is a diagram illustrating implementation details of the interaction system according to an embodiment of the present invention. The processing circuit 122 (more particularly the processor therein) may execute one or more program modules (e.g. one or more applications (APP), drivers, etc.) corresponding to the method, in order to control the operations of the electronic device 120. The software layer of the electronic device 120 may comprise an application layer and an OS kernel for performing upper-layer control, and the hardware layer of the electronic device 120 may comprise a wireless module (which may be taken as an example of the communications module 126) and the touch-sensitive panel 124, for performing lower-layer control, such as the interactions between the input device 110 and the electronic device 120, wherein the applications and drivers are respectively positioned in the application layer and the OS kernel, but the present invention is not limited thereto.

According to some embodiments, when it is detected that the distance D between the detection points P1 and P2 is equal to the predetermined distance, the touch-sensitive panel 124 may output the detection result and the auxiliary information corresponding to the input device 110, wherein according to the detection result and the auxiliary information, the electronic device 120 (especially the processing circuit 122 thereof) may control the display content outputted by the display module 128 to correspond to the input device 110. The auxiliary information may comprise characteristic parameters corresponding to various features of the input device 110. Examples of these features may include, but are not limited to: the shape, size (such as the length, width, etc.), the location and azimuth (such as the origin coordinate and angle) of the display content corresponding to the input device 110, and product model number. In some embodiments, the input device database may comprise at least one portion (e.g. part or all) of the auxiliary information.

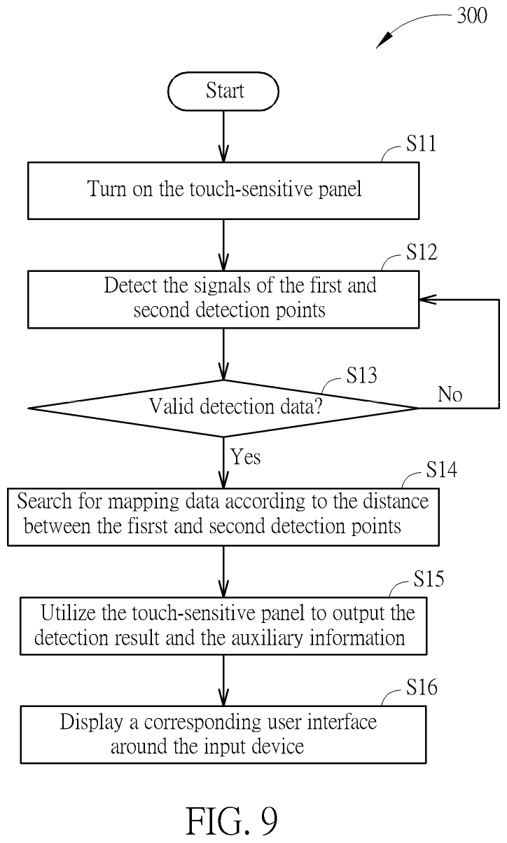

FIG. 9 is a diagram illustrating a working flow 300 of the method according to an embodiment of the present invention. For better understanding, the first detection point and the second detection point in the working flow 300 are respectively described using the detection points P1 and P2.

In Step S11, the electronic device 120 (especially the processing circuit 122 thereof) may turn on the touch-sensitive panel 124, for example, by utilizing the control circuit 124C, but the present invention is not limited thereto.

In Step S12, the touch-sensitive panel 124 may detect the signals of the detection points P1 and P2 in order to generate detection data.

In Step S13, the touch-sensitive panel 124 may check whether the detection data is valid detection data or not. If yes, Step S14 is entered; and if not, Step S12 is entered.

In Step S14, the touch-sensitive panel 124 may find (more particularly, search for) the mapping data according to the distance D between the detection points P1 and P2. For example, based on the mapping relationships in the input device database, the touch-sensitive panel 124 may refer to a certain predetermined distance among the predetermined distances D1, D2, D3, D4 . . . to find (more particularly, search for) the corresponding ID among the IDs ID1, ID2, ID3, ID4 . . . as the detection result.

In Step S15, the electronic device 120 may utilize the touch-sensitive panel 124 to output the detection result and the auxiliary information, for the processing circuit 122 to use.

In Step S16, the electronic device 120 (especially the processing circuit 122 thereof) may control the electronic device 120 to display the corresponding user interface around the input device 110.

According to some embodiments, one or more steps may be added to, modified, or removed from the working flow 300.

According to some embodiments, the touch-control mechanism of the touch-sensitive panel 124 may be modified, and the input device 110 may change correspondingly. Examples of the touch-control mechanism may include, but are not limited to: capacitive touch-control mechanism, electromagnetic touch-control mechanism, etc. Regarding the capacitive touch-control mechanism, the input device 110 may provide dual active signal points (e.g. signals in different frequencies, such as signals of 25 kHz and 170 kHz or signals of other frequencies; or signals in the same frequency, such as signals of 25 kHz or any of other frequencies) via the terminals 111 and 112. Regarding the electromagnetic touch-control mechanism, the input device 110 may utilize the terminals 111 and 112 to make the touch-sensitive panel 124 detect specific electromagnetic signals at the detection points P1 and P2, wherein the electromagnetic inductive value of the touch-sensitive panel 124 is changed. In addition, when there is a need, the input device 110 may be configured with a built-in battery.

According to some embodiments, the present invention may provide an optimal connection process, while the related arts require a user to perform at least three steps to complete the connection. According to the present invention, the user only needs to place the input device 110 on the screen, and the system can create a connection immediately after the input device 110 is properly placed.

According to some embodiments, the input device 110 may have a ring-shaped structure, wherein when the input device 110 (such as an active stylus) scrolls on the touch-sensitive panel 124, the touch-sensitive panel 124 may detect that the distance D between the detection points P1 and P2 remains unchanged.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device, applicable to interact with an input device, comprising:
a touch-sensitive panel, arranged to perform sensing on a first terminal and a second terminal of the input device, to detect a first detection point corresponding to the first terminal and a second detection point corresponding to the second terminal, wherein when the input device is placed on the touch-sensitive panel, the first detection point corresponds to a location of the first terminal on the touch-sensitive panel, and the second detection point corresponds to a location of the second terminal on the touch-sensitive panel, and when a distance between the first detection point and the second detection point is equal to a predetermined distance, the touch-sensitive panel generates a detection result to indicate that the input device is placed on the touch-sensitive panel is the input device; and
a processing circuit, coupled to the touch-sensitive panel, the processing circuit arranged to control operations of the electronic device, wherein at least according to the detection result, the processing circuit controls a display content outputted by a display module of the electronic device to correspond to the input device.

2. The electronic device of claim 1, further comprises an input device database, wherein the distance between the first detection point and the second detection point corresponds to an input device database of the electronic device, and the input device database comprises a mapping relationship between the predetermined distance and an identifier (ID) of the input device; and based on the input device database, the touch-sensitive panel generates the detection result, wherein the detection result comprises the ID.

3. The electronic device of claim 2, wherein the input device database comprises mapping relationships of a plurality of predetermined distances and respective IDs of a plurality of input devices; and the plurality of input devices comprise the input device, said respective IDs comprise the ID, and the plurality of predetermined distances comprise the predetermined distance and differ from one another.

4. The electronic device of claim 1, wherein when the distance between the first detection point and the second detection point is equal to the predetermined distance, the touch-sensitive panel outputs the detection result and auxiliary information corresponding to the input device; and according to the detection result and the auxiliary information, the processing circuit controls a display content outputted by the display module to correspond to the input device.

5. The electronic device of claim 1, wherein when the input device is placed on the touch-sensitive panel, the first terminal and the second terminal touch or approach the touch-sensitive panel, in order to allow the touch-sensitive panel to detect the first detection point and the second detection point.

6. An input device, applicable to interact with an electronic device, comprising:
a first terminal, arranged to trigger a touch-sensitive panel of the electronic device to detect a first detection point corresponding to the first terminal, wherein when the input device is placed on the touch-sensitive panel, the first detection point corresponds to a location of the first terminal on the touch-sensitive panel; and
a second terminal, arranged to trigger the touch-sensitive panel to detect a second detection point corresponding to the second terminal, wherein when the input device is placed on the touch-sensitive panel, the second detection point corresponds to a location of the second terminal on the touch-sensitive panel;
wherein when a distance between the first detection point and the second detection point is equal to a predetermined distance, the touch-sensitive panel generates a detection result to indicate that the input device is placed on the touch-sensitive panel; and at least according to the detection result, the electronic device controls a display content outputted by a display module of the electronic device to correspond to the input device.

7. The input device of claim 6, wherein the distance between the first detection point and the second detection point corresponds to an input device database of the electronic device, the input device database comprises a mapping relationship between the predetermined distance and an identifier (ID) of the input device; and based on the input device database, the touch-sensitive panel generates the detection result, wherein the detection result comprises the ID.

8. The input device of claim 7, wherein the input device database comprises mapping relationships between a plurality of predetermined distances and respective IDs of a plurality of input devices; and the plurality of input devices comprise the input device, said respective IDs comprise the ID, and the plurality of predetermined distances comprise the predetermined distance and differ from one another.

9. The input device of claim 6, wherein when the distance between the first detection point and the second detection point is equal to the predetermined distance, the touch-sensitive panel outputs the detection result and auxiliary information corresponding to the input device; and according to the detection result and the auxiliary information, the electronic device controls a display content outputted by the display module to correspond to the input device.

10. The input device of claim 6, wherein when the input device is placed on the touch-sensitive panel, the first terminal and the second terminal touch or approach the touch-sensitive panel, in order to allow the touch-sensitive panel to detect the first detection point and the second detection point.
